(19) United States
(12) Patent Application Publication
(10) Pub. No.: US 2015/0325976 A1
(43) Pub. Date: Nov. 12, 2015

(54) A LASER AND A METHOD OF CONTROLLING THE GENERATION OF A LIGHT

(71) Applicant: Macquarie University, New South Wales (AU)

(72) Inventors: David James Spence, Forestville (AU); Helen Margaret Pask, Seaforth (AU); Andrew Lee, Kings Langley (AU)

(73) Assignee: Macquarie University, New South Wales (AU)

(21) Appl. No.: 14/412,402

(22) PCT Filed: Jul. 5, 2013
(86) PCT No.: PCT/AU2013/000735

§ 371 Date: Dec. 31, 2014

Related U.S. Application Data
(60) Provisional application No. 61/668,126, filed on Jul. 5, 2012.

(51) Int. Cl. H01S 3/108; H01S 3/16; H01S 3/30; H01S 3/109

(52) U.S. Cl. CPC H01S 3/1086; H01S 3/109; H01S 3/1611; H01S 3/1671; H01S 3/30

(57) ABSTRACT

A laser configured to optimise output power at a desired wavelength, by suppression of unwanted Stokes orders in a Raman cascade, the laser comprising a resonating structure configured to resonate precursor light and Raman light frequencies, having a Raman medium configured to interact with the precursor resonating light to generate the Raman light; a control nonlinear medium configured to reduce an extraction of power from the precursor resonating light by the Raman process; and an output nonlinear medium configured to interact with the precursor resonating light to generate a desired output light thereby extracting power from the precursor resonating light; whereby the control nonlinear medium reduces the extraction of power from the precursor resonating light by the Raman process to enhance the extraction of power from the precursor resonating light by the output nonlinear medium interacting with the precursor resonating light thereby increasing the power of desired output the light.

### TECHNICAL FIELD

The disclosure herein generally relates to a laser and a method for increasing generation of a light.

### BACKGROUND

Solid-state Raman lasers have proven capacity to access a wide range of infrared, visible and UV wavelengths. A recent development in the field has been the realization of efficient, continuous-wave (CW) frequency-selectable laser sources. These are CW intracavity Raman lasers, where a high-Q cavity is provided for both the fundamental and Stokes optical fields such that the fundamental field can reach the threshold for stimulated Raman scattering (SRS). Visible output is then generated by second-harmonic (SHG) or sum-frequency mixing (SFM) of the intense intracavity fields in a suitable nonlinear crystal. In this way, many different “sets” of output frequencies can be generated, depending on the Raman-shift of the Raman crystal, and whether the resonator enables cascading to higher Stokes orders.

Some output frequencies generated by nonlinear frequency conversion may be of lower power than expected or inhibited, however, because of the unexpected generation of unwanted Stokes, which in this case represented a loss mechanism. The strength of the nonlinear frequency generation process may not be strong enough to hold the intensity of the longest-wavelength intracavity field below the SRS threshold for the unwanted Stokes order.

### SUMMARY

Disclosed herein is a method for increasing generation of a light. The method comprises the step of using a nonlinear process that reduces the extraction of power from a precursor resonating light by a Raman process in which the precursor resonating light interacts with a Raman medium to generate a resonating Raman light. The reduction in the extraction of power from the precursor resonating light enhances the extraction of power from the precursor resonating light by another nonlinear process that generates the light.

In an embodiment, the step of using a nonlinear process to reduce the extraction of power from the precursor resonating light comprises the step of passing the precursor light through a second order nonlinear medium tuned for interacting with the precursor light and the resonating Raman light for generating another light. The other light may have a frequency that is the sum of the precursor light's frequency and the resonating Raman light's frequency. A resonating Raman light gain due to the precursor resonating light interacting with the Raman medium may be less than a resonating Raman light loss from the passing of the precursor light through the second order nonlinear medium. The second order nonlinear medium may be tuned for interacting with the precursor light and the resonating Raman light for generating the other light. Tuning the second order nonlinear medium may comprise the step of orientating the second order nonlinear medium. The step of tuning the second order nonlinear medium may comprise the step of changing the temperature of the second order nonlinear medium.

An embodiment comprises the step of passing the resonating precursor light through more than at least one of 20 mm, 10 mm, 5 mm, 3 mm and 1 mm of the second order nonlinear medium.

In an embodiment the second order nonlinear medium comprises a crystal of at least one of lithium triborate, beta barium borate, lithium iodate, potassium niobate, gallium selenide, lithium niobate, bismuth borate, and potassium titanyl phosphate.

An embodiment comprising the step of passing the precursor light through no more than at least one of 10 mm, 5 mm, 3 mm and 1 mm of the Raman medium.

In an embodiment, the other nonlinear process may comprise a nonlinear interaction of the precursor resonating light with another second order nonlinear crystal. The other second order nonlinear crystal may comprise of at least one of lithium triborate, beta barium borate, lithium iodate, potassium niobate, gallium selenide, bismuth borate, and potassium titanyl phosphate. The precursor light may be passed through no more than at least one of 10 mm, 5 mm, 3 mm and 1 mm of the other second order nonlinear crystal.

In an embodiment, the Raman medium comprises a crystal of at least one of tungstate, potassium gadolinium tungstate, barium tungstate, molybdenate, barium nitrate, vanadate, gadolinium vanadate, and diamond.

An embodiment comprises the step of generating the precursor resonating light using a laser medium having an invertable population for generation of a laser light. The laser medium may comprise the Raman medium. The laser medium may comprise gadolinium vanadate doped with rare earth ions. The precursor resonating light may be generated within the light resonating structure. Alternatively, the precursor resonating light may be generated external of the light resonating structure. The precursor resonating light may be coupled into the light resonating structure.

In an embodiment, the Raman light is a selected from one of a cascade of resonating Raman lights.

An embodiment comprises the step of using the nonlinear process to suppress the extraction of power from the precursor resonating light by the Raman process.

Disclosed herein is a laser. The laser comprises a light resonating structure configured to resonate a precursor resonating light. The light resonating structure has a Raman medium configured to interact with the precursor resonating light when so resonating in the light resonating structure to generate a Raman light by a Raman process. The laser comprises a nonlinear medium configured to reduce an extraction of power from the precursor resonating light by the Raman process. The laser comprises another nonlinear medium configured to interact with the precursor resonating light to generate a light thereby extracting power from the precursor resonating light. In use the nonlinear medium reduces the extraction of power from the precursor resonating light by the Raman process to enhance the extraction of power from the precursor resonating light by the other nonlinear medium interacting with the precursor resonating light thereby increasing the power of the light.

In an embodiment, the nonlinear medium comprises a second order nonlinear medium configured to have the resonating precursor light pass therethrough and being tunable to interact with the precursor light and the resonating Raman light for generating another light having a frequency that is the sum of the precursor light's frequency and the resonating Raman light's frequency.

An embodiment of the laser is configured to provide a resonating Raman light gain due to the precursor resonating light interacting with the Raman medium that is less than a resonating Raman light loss from the passing of the precursor light through the second order nonlinear medium. The laser may comprise a second order nonlinear medium tuner arranged to tune the second order nonlinear medium. The second order nonlinear tuner may be arranged to orientate the second order nonlinear medium. The second order nonlinear medium tuner may be arranged to control the temperature of the second order nonlinear medium. The second order nonlinear medium may be arranged such that the resonating precursor light passes through more than at least one of 20 mm, 10 mm, 5 mm, 3 mm and 1 mm thereof.

In an embodiment, the second order nonlinear medium comprises a crystal of at least one of lithium triborate, beta barium borate, lithium iodate, potassium niobate, gallium selenide, lithium niobate, bismuth borate, and potassium titanyl phosphate.

In an embodiment, the Raman medium is arranged such that the precursor light passes through no more than at least one of 10 mm, 5 mm, 3 mm and 1 mm thereof.

In an embodiment, the other nonlinear medium comprises another second order nonlinear crystal. The other second order nonlinear crystal may comprise of at least one of lithium triborate, beta barium borate, lithium iodate, potassium niobate, gallium selenide, bismuth borate, and potassium titanyl phosphate. The other second order nonlinear crystal may be arranged such that the precursor light passes through no more than at least one of 10 mm, 5 mm, 3 mm and 1 mm thereof.

In an embodiment, the Raman medium comprises a crystal of at least one of tungstate, potassium gadolinium tungstate, barium tungstate, molybdenate, barium nitrate, vanadate, gadolinium vanadate, and diamond.

An embodiment comprises a laser medium having an invertable population by which the precursor light is generated. The laser medium may comprises the Raman medium. The laser medium may comprises gadolinium vanadate doped with rare earth ions. The light resonating structure may have the laser medium. For example, for a resonating structure having two mirrors facing each other, the laser medium is disposed between them. That is, light resonating within the resonating structure passes through the laser medium. Alternatively, the precursor resonating light may be generated external of the light resonating structure and an embodiment comprises a precursor resonating light coupler arranged to couple into the light resonating structure the precursor resonating light. The precursor resonating light coupler may comprise, for example, any one of a frequency selective mirror, a prism, and a Pockels cell. Generally any suitable precursor resonating light coupler may be used. The precursor resonating light may be generated by a Raman laser, for example.

In an embodiment, the nonlinear medium suppresses the extraction of power from the precursor resonating light by the Raman process.

The precursor resonating light may be continuous for more than 0.01 seconds (“continuous wave”), or it may comprises at least one pulse. Each of the at least one pulse may be less than at least one of 1 microsecond, 100 nanoseconds, 10 nanoseconds and 1 nanoseconds long.

Where possible, any of the features of an embodiment of a laser disclosed above may be combined with any of the features of an embodiment of a method disclosed above.

### BRIEF DESCRIPTION OF THE FIGURES

Embodiments will now be described by way of example only with reference to the accompanying figures in which:

FIG. 1 shows a schematic diagram of an embodiment of a laser.

FIG. 2 show a flow diagram of a method of controlling the generation of a second light by the laser of FIG. 1.

FIG. 3 show graphs of results from measurements of the laser output.

FIGS. 4 and 5 show experimental results from a laser similar to that of FIG. 1.

FIGS. 6 and 7 show results from a model of a laser similar to that of FIG. 1.

FIGS. 8 to 12 show block diagram that summarize example modes of a second light reducer.

### DESCRIPTION OF EMBODIMENTS

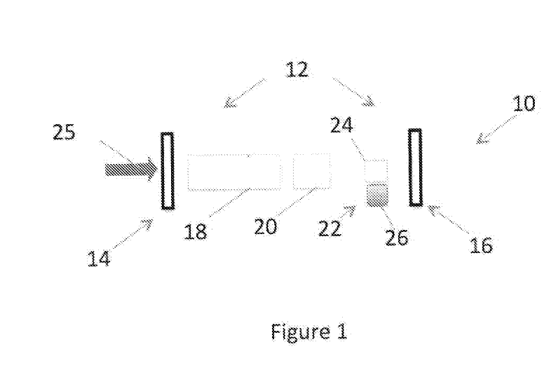

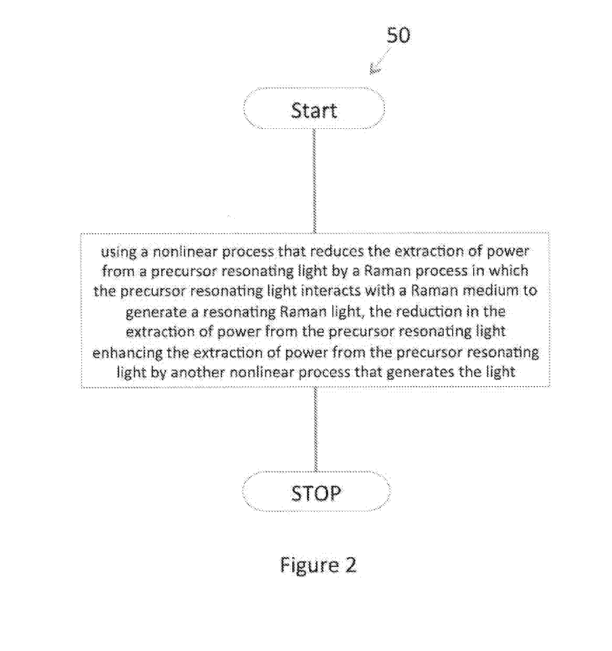

FIG. 1 shows an embodiment of a laser generally indicated by the numeral 10. FIG. 2 show a flow diagram of a method 50 of increasing generation of a light from the laser 10. The laser has a light resonating structure 12 comprising end mirrors 14 and 16. The light resonating structure 12 is configured to resonate a first light (“a precursor resonating light”). The end mirrors are highly reflective at a first light wavelength. In this but not all embodiments, the light resonating structure 12 has a laser medium 18 in the form of a crystal of gadolinium vanadate doped with rare earth ions. The laser medium 18 is disposed between the end mirrors 14,16. The rare earth ion is neodymium, but any suitable rare earth ion including ytterbium, erbium and holmium may be used. Any suitable laser medium may alternatively be used, for example ytterbium doped vanadate. The rare earth ions present an invertable population of electrons for the generation of a laser light when illuminated by a suitable pump light 25, for example light from a laser diode having a wavelength of about 808 nm or 880 nm or light from a titanium sapphire laser although any suitable light generated by any suitable light source may be used. In this but not all embodiments, the laser light is the first light. The pump light 25 of this embodiment is continuous wave, enabling a continuous wave output from the laser. It will be appreciated however, that the pump light may be pulsed in which case the output from the laser may also be pulsed. The laser may include a Q-switch or a mode locker (for example a saturable absorber) in which case the output from the laser may be pulsed.

The crystal 18 may be dimensioned and orientated such that the first light when so resonating passes through no more than 5 mm of the crystal 18 per pass. In another embodiment, the crystal may be dimensioned and orientated such that the first light when so resonating travels through no more that at least one of 10 mm, 3 mm and 1 mm of the crystal 18 per pass. Using a shorter crystal may reduce scattering and absorption losses and consequently the performance of the laser may be better than cases in which a longer crystal is used.

In another embodiment, the first light may be generated using at least the laser light. The first light may be generated by a suitable nonlinear interaction between a suitable nonlinear medium and at least the laser light. For example, the laser material may be neodymium doped yttrium aluminum garnet and the nonlinear process comprise at least one of a second order nonlinear process and a Stimulated Raman Scattering (SRS) process.

In the embodiment of FIG. 1, the laser medium 18 is capable of supporting a SRS process because the host material gadolinium vanadate has a significant Raman cross-section. The first light generated by the crystal 18 also interacts with the crystal 18 via a SRS process to generate a second light (“Raman light”), which in this embodiment is the first stokes. The light resonating structure 12 is also configured to resonate the second light. The end mirrors 14,16 are highly reflective at a second light wavelength.

The laser 10 has a second light generation reducer 22 disposed within the light resonating structure, the second light generation reducer 22 having a reduction mode in which the light generation reducer 22 reduces the generation of the second light and a further mode in which the generation of the second light is not so reduced. In this embodiment, the light generation reducer can suppress the generation of a coherent beam of the second light in the reduction mode. In the context of this application, suppression of the generation the second light should be understood to mean greater than 99%, and perhaps greater than 99.99% suppression. However, the reduction is not necessarily complete. The reducer may be used to reduce the second light by more than, say, any one of 10%, 50%, 90%, 95% and 99%. The amount of second light reduction may be anywhere in the range of 0% to 100%.

In the embodiment of FIG. 1, the second light generation reducer 22 has a second order nonlinear medium 24 in the form of a crystal of lithium triborate, although any suitable nonlinear medium may be used. Examples of suitable nonlinear media may include crystals of beta barium borate, lithium iodate, potassium niobate, gallium selenide, lithium niobate, bismuth borate, and potassium titanyl phosphate. In the reduction mode the second order nonlinear medium is tuned for interacting with the first light and the second light to generate a third light by a second order nonlinearity, the third light having a frequency that is the sum of the first light's frequency and the second light's frequency. That is, the crystal is tuned for sum frequency generation. This does not necessarily result in the generation of the third light, however. For example, when the second light is completely suppressed no third light is generated. When the generation of the second light is reduced but not suppressed there may still be between 1% and 99% of the maximum available.

The applicants have found that suppression may be achieved when the gain due to at least one interaction between the Raman medium and the first light is less than a second light loss due to the interaction between the second order nonlinear medium and the first light.

The second light generation reducer 22 has a second order nonlinear medium tuner 26 arranged to tune the second order nonlinear medium. The tuner 26 is operable for selection of one of the reduction mode and the further mode. The second order nonlinear medium tuner 26 can change the phase matching of the crystal 24. When the crystal 24 is phase matched for the generation of the third light, the wave vector (that is, the refractive index for a light multiplied by angular frequency of the light divided by the speed of light) of the third light is equal to the sum of the wave vectors of the second and third light. Phase matching may be realised, as in this embodiment, by orientating the crystal 24—so called angle tuning. The second order nonlinear medium tuner 26 has a second order nonlinear medium orientation controller in the form of a rotatable that the crystal 24 sits on. The crystal is tuned by operating a knob that causes the rotatable platform to rotate and so orientate the crystal 24. The platform can be rotated until the generation of the second light is suppressed in which case the crystal is sufficiently close to a phase matching condition. In that case, the generation of the second light is suppressed—perhaps completely. There is generally no third light generated. As the platform is further rotated, the crystal orientation will increasingly deviate from the orientation at which the phase matching condition is met and the amount of second light generated will increase.

In another embodiment, the second order nonlinear medium tuner comprises a second order nonlinear medium temperature controller. The temperature controller may comprise a heated and/or cooled platform 26 on which the nonlinear crystal 24 sits. A control unit monitors the temperature of the platform which has an embedded or otherwise coupled temperature sensor and controls a heater and/or cooler coupled to the platform so that the embedded sensor reads a temperature close to a set point temperature. Phase matching is achieved at a phase matching temperature that is dependent on the type of crystal used and the crystal's cut. Moving the set point away from the phase matching temperature causes the amount of second light generated to increase.

The crystal 24 may be dimensioned and cut so that on each pass the first light when so resonating travels through more than 10 mm of the second order nonlinear medium 24 per pass. In other embodiments, this value may be at least one of 20 mm, 5 mm, 3 mm, 1 mm and 0.25. The longer the crystal 24 the stronger the suppressing mechanism, however scattering and absorption losses may also increase which may degrade overall laser performance.

The laser 10 comprises another nonlinear medium 20 disposed within the light resonating structure 12 configured for interacting with a light resonating within the light resonating structure 12 to generate a fourth light. For example, the other nonlinear medium 20 may be a second order nonlinear crystal, for example lithium triborate, cut for interacting with the first light to generate a fourth light having twice the frequency of the first light (a second harmonic generation process). Alternatively, the second light may be a nth order stokes of the first light, and the nonlinear medium 20 may be a second order nonlinear crystal cut to interact with the first light and another stokes light having an order less than n to generate a light having a frequency that is the sum of that of the other stokes light and the first light. In yet another alternative, the nonlinear medium 20 may interact with two lights which are two different stokes orders of the first light to generate a light that has a frequency that is the sum of the frequencies of two different stokes orders. The number n may be a counting number such as 2, 3, 4 . . . . In still yet another example, the nonlinear medium 20 may interact with the first light and a light that used to create the first light to generate a light that has a frequency that is the sum of the first light frequency and the frequency of the light used to create the first light.

The second order nonlinear crystal 24 and the other nonlinear medium 20 may both be tuned to obtain a desired output wavelength. For example, the second order nonlinear crystal 24 may be tuned to suppress the first stokes and the other nonlinear medium 20 may be tuned for frequency doubling of the fundamental laser wavelength. The second order nonlinear crystal may then be tuned to suppress the second stokes and the other nonlinear medium 20 tuned for producing a light having a frequency that is the sum of that of the fundamental laser wavelength and the first stokes. Generally any suitable tuning arrangement may be used.

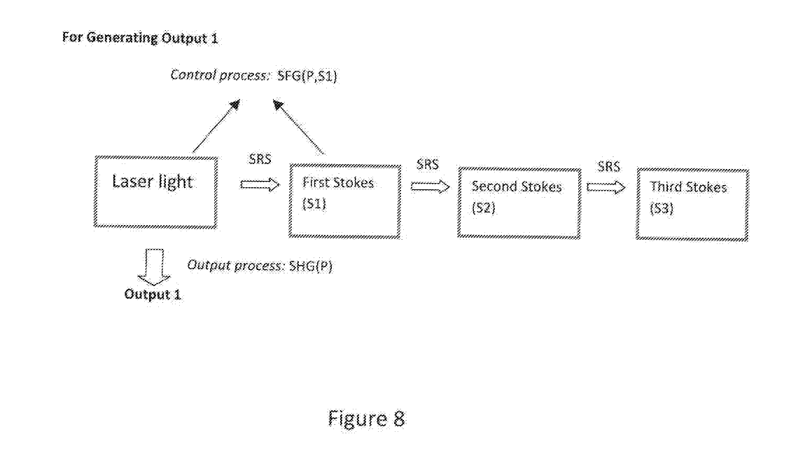

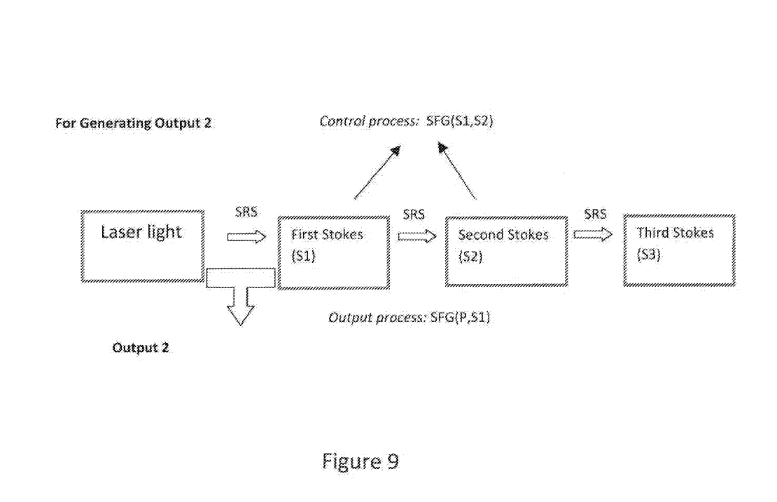

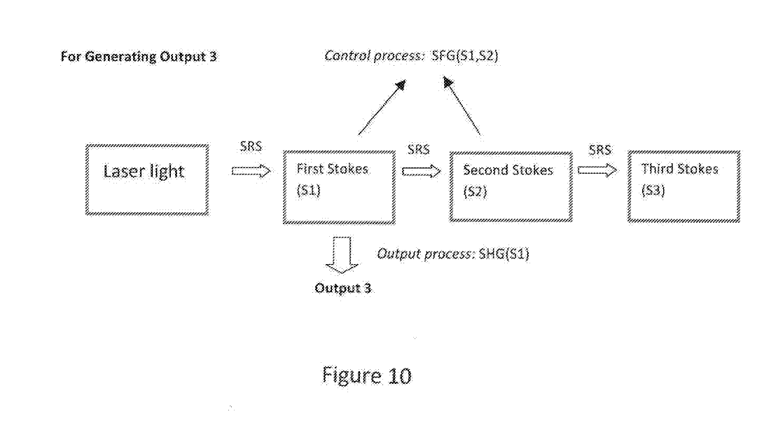

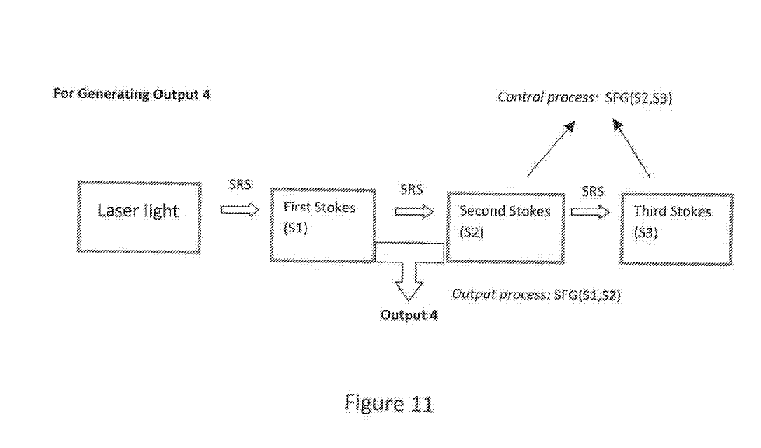

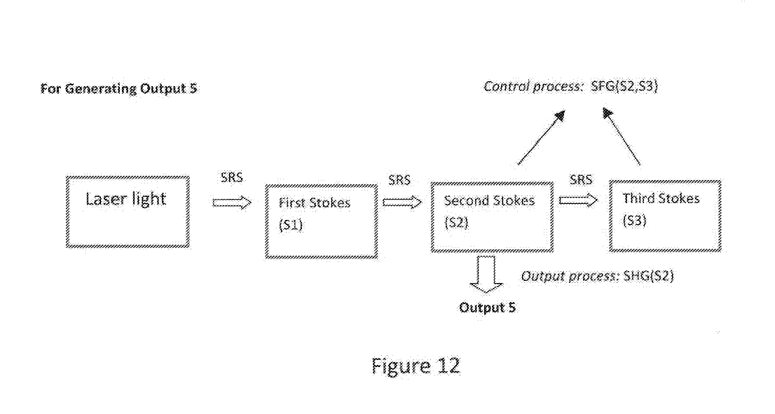

FIGS. 8 to 12 show block diagrams that summarize example modes of the second light reducer. The power from a laser light generated within the light resonating structure, may cascade through various stokes (first stokes, second stokes, third stokes, and possibly further stokes). The control process implemented by the second light reducer is tunable to cause a sum frequency generation (SFG) processes using two adjacent wavelengths in the cascade, and consequently stop the cascade at the shorter wavelength. The shorter wavelength can then be used for any desired purpose, including the generation of another light using SFG, and second harmonic generation (SHG), for example.

The first light when so resonating may travel through no more than at least one of 10 mm, 5 mm, 3 mm 1 mm and 0.25 mm of the other nonlinear medium 20 per pass. Shorter crystals lower the scattering and absorption loss. Thus, within limits, shortening the crystal length may improve laser performance.

Generally, the generation of the fourth light may be by a process that competes with the process that generates the second light. Consequently, when an operator of the laser 12 desires the fourth light rather than the second light, the operator may enable the reduction mode of the second light generation reducer 22 to reduce or suppress the generation of the second light which may increase the power of the fourth light. When the operator desires the second light, however, the operator may enable the other mode.

### EXAMPLE

By providing a sufficiently strong ‘over-critical’ sum frequency mixing (SFM) interaction between a field and its Stokes-shifted wavelength, (the applicant) has prevented power being transferred to a Stokes wavelength and so halted a SRS cascade. The applicant can choose where they wish to halt the SRS cascade by temperature- or angle-tuning the SFM crystal to over-couple the last desired Stokes order with the unwanted next order. This method of control may present only a very small additional loss to the desired oscillating fields. The applicant's experimental results demonstrate the effectiveness of this novel approach, and they report a wavelength-selectable laser generating output at 532 nm, 559 nm, 586 nm and 620 nm. Controlling the cascade led to a 48% improvement in green power and a 67% improvement in yellow power.

The applicant demonstrates this concept using an intracavity doubled self-Raman laser that can cascade to the second Stokes wavelength, giving potential access to five selectable wavelengths from the green to the red. The laser is a CW intracavity self-Raman laser, but with an additional lithium triborate (LBO) crystal 24 as shown in FIG. 1. One ‘output’ crystal 20 is used to select the output wavelength of the laser, by temperature tuning the crystal to mix the desired fields into a visible output field: SHG of the fundamental for green output, SFM of the fundamental and 1^{st}-Stokes for lime output, SHG of the 1^{st}-Stokes for yellow output, and SFM of the 1^{st}- and 2^{nd}-Stokes for orange-red output.

The second ‘control’ crystal 24 is used to control the Raman cascade and prevent power cascading to undesired Stokes orders. For generating green output, the applicant wishes to suppress all Stokes generation, and so set the control crystal for over-critical SFM of the fundamental and 1^{st}-Stokes field. For generating lime or yellow output, the applicany needs the 1^{st}-Stokes but do not want power to cascade to the 2^{nd}-Stokes, and so they set the control crystal for over-critical SFM of the 1^{st} and 2^{nd}-Stokes fields, halting the Raman cascade at the 1^{st}-Stokes field. The range of modes of operation of the laser, along with the cascade control that the applicant wishes to achieve, are summarized in Table 1.

TABLE 1
Summary of the configurations used to generate each visible wavelength using a χ(2)
Output process to couple the intracavity fundamental (F), 1st-Stokes (S1) and 2nd-
stokes (S2) fields. A χ(2) Control process is selected to suppress
unwanted intracavity fields.

| Wavelength | Output process | LBO Temp | Unwanted field | Control process | LBO temp |
|---|---|---|---|---|---|
| 532 nm | SHG (F) | 155° C. | S1 | SFG (F, S1) | 94° C. |
| 559 nm | SFG (F, S1) | 94° C. | S2 | SFG (S1, S2) | 8° C. |
| 586 nm | SHG (S1) | 45.5° C. | S2 | SFG (S1, S2) | 8° C. |
| 620 nm | SFG (S1, S2) | 8° C. | — | — | — |

The laser resonator comprised two resonator mirrors M1 indicated by numeral 14 and M2 indicated by numeral 16, each having high transmission (T>95%) at 880 nm and high reflectivity for the fundamental, first and second Stokes wavelengths (R>99.994% at 1063 nm-1320 nm). M1 was a plane mirror and M2 had a radius-of-curvature of 50 cm. The 0.3 atomic % Nd:GdVO₄ self-Raman crystal had dimensions 4×4×20 mm, and was anti reflection coated at 1063 nm-1320 nm.

Both LBO crystals were cut for type 1 non-critical-phase-matching and AR-coated at 1063 nm-1320 nm. All crystals were wrapped in indium foil and mounted in copper blocks. The laser crystal was water-cooled, while the LBO crystals were heated or cooled using a resistor/TEC combination. All resonator components were positioned closely together and the resonator had a length of 48 mm.

The laser crystal was pumped with up to 10 W from a fibre-coupled 880 nm laser diode (100 μm core, 0.22 NA) focused to a 300 μm diameter spot onto the front surface of the Nd:GdVO₄ crystal. The visible emission was generated in both directions, with only the portion passing through M2 being collected and reported here. The transmission of M2 in the visible was ˜92%. The intracavity optical fields at the fundamental, first and second Stokes wavelengths were monitored using a fibre-coupled spectrometer from leakage through M2.

The applicant performed two sets of experiments. They first measured the output characteristics of the laser at each of the possible visible wavelengths with the control LBO crystal maintained at room temperature and the output LBO temperature tuned to achieve phase matching to generate the desired visible wavelength. By maintaining the control LBO at room temperature, a temperature not corresponding to any phase matching interaction within the resonator, its effect on the laser dynamics was merely to contribute a small resonator loss.

The threshold absorbed pump-power for emission at the green, yellow, lime and orange-red wavelengths were 100 mW, 410 mW, 410 mW and 1.64 W respectively. These values also correspond to the thresholds for the fundamental, 1^{st}-Stokes and 2^{nd}-Stokes fields. Maximum visible emission was achieved in the lime, generating ˜1.3 W (13.8% diode-to-visible conversion efficiency), followed by green generating ˜1 W (11% conversion efficiency), yellow generating ˜750 mW (7.96% conversion efficiency) and orange-red generating ˜190 mW (2% conversion efficiency). It should be re-iterated that the output power measured here was only that emitted through mirror M2 and does not include visible power exiting mirror M1. The beam quality of each visible output was very good, the green, lime and yellow outputs having M²˜1 at threshold, with yellow and lime increasing to M²˜1.5, and green to M²˜3 at maximum pump power. The orange-red field had M²˜1.5 at threshold and this rose to M²˜2.4 at max pump power.

The applicant then repeated these experiments, but using the control LBO crystal to control the Raman cascade by temperature tuning it to present over-critical SFM for the appropriate fields as shown in Table 1.

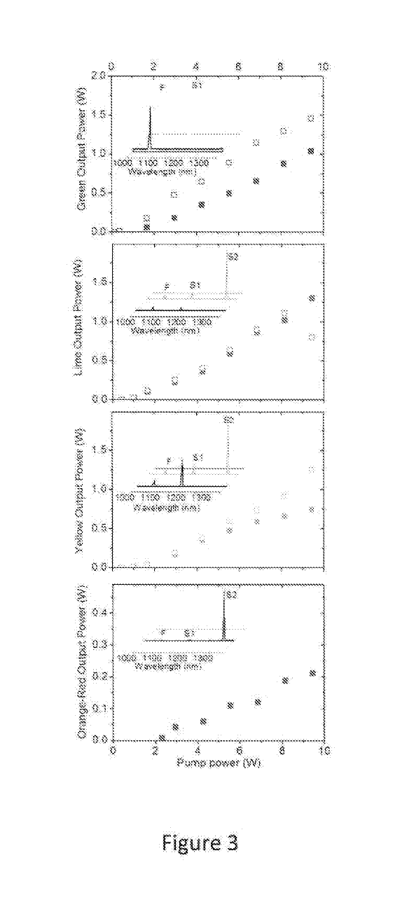

FIG. 3 shows the results of the experiments to control the Raman cascade, showing power scaling at each visible wavelength as a function of absorbed pump power with and without Stokes cascade control, open and closed squares respectively. The shown inset are plots of the residual IR field observed through M2 for 8 W absorbed pump with and without Stokes cascade control, black and grey lines respectively. It can be seen that there is significant improvement in the power scaling performance of the yellow and green output from the system when the control crystal is utilized. In the case of yellow emission, up to 67% increase in output is observed, while in the case of green emission we observe 48% increase. This increase is attributed to complete suppression of the unwanted fields. This spectral data is shown inset for each of the power scaling plots of FIG. 3. Two spectra are shown, both taken for an absorbed pump power of 8 W, the grey one without over-critical SFM from the control crystal, and the black line with over-critical SFM. In the case of green power scaling, complete elimination of the 1^{st}-Stokes field is achieved, while in the cases of yellow and lime generation, the 2^{nd}-Stokes field is eliminated.

There is little improvement in the lime output, despite the fact that the control crystal was able to prevent the unwanted power transfer to the 2^{nd}-Stokes, indicating that the unwanted order was not strongly affecting the laser performance in this case.

We are using SFM mixing in this laser in two ways—over-critical SFM is used to control the cascade, and sub-critical SFM is used to mix fields to generate visible output. The lengths of the output and control LBO crystals and the ˜250 μm cavity mode size in this laser are tailored so that they fulfill these different functions. The longer, 15 mm LBO crystal is used as the control LBO crystal, to ensure that its SFM strength is greater than the critical level, so suppressing the cascade. On the other hand, the output LBO crystal is shorter, so that when this crystal is tuned to generate output through the SFM process, its SFM strength is sub-critical.

The applicant has also demonstrated the generation of multi-Watt level emission in the green, lime and yellow from another self-Raman laser. In the other self-Raman laser, the applicant did not observe unwanted over-critical SFG when configuring that laser for lime output. This indicates that in that resonator, the applicant could not increase the SFG coupling to a level required to suppress the SRS process. This was likely due to the relatively poor beam quality of that laser and larger mode size in that laser (˜450 μm); the output beams had M² values of order 6, resulting from the very strong thermal lens induced in the gain crystal, combined with the short-radius-of-curvature output coupler and short resonator length required to maintain stability.

In this example the applicant has demonstrated a novel method of controlling the SRS cascading within an intracavity Raman laser generating up to the 2^{nd}-Stokes output line. Control was achieved through the use of a second intracavity frequency-mixing crystal which provides over-critical SFM between the last desired laser field and the next undesired Stokes field. This has been used to substantially increase the output power from a wavelength-switchable self-Raman laser that produced emission in the green, lime, yellow, orange-red wavelengths.

### Further Example and Theoretical Discussion

The modeling and discussion below relates to control in a laser with one second order nonlinear crystal. It will be appreciated that another second order nonlinear crystal may be included in the modeled laser in accordance with the above disclosure.

### Description of Model

The applicant first describes the general laser design that they modeled. The linear two-mirror cavity contains a laser material, a Raman-active material, and a χ⁽²⁾ material for frequency mixing. In many lasers, a single “self-Raman” crystal acts both as laser gain and Raman material, but the model is presented for the more general case. The laser material is longitudinally-pumped through an end mirror designed for high transmission at the pump wavelength. The laser crystal generates a fundamental field inside the cavity, and this intracavity fundamental field is Raman-shifted to generate a first-Stokes field; the cavity mirrors are designed to be highly reflective for both of these fields. Power is coupled out of the cavity by the frequency mixing crystal—this crystal is temperature tuned to select between second harmonic generation (SHG) of the fundamental field, SHG of the Stokes field, and sum-frequency mixing (SFM) of the two fields. The visible output exits through the end mirror with high transmission. A second visible beam is generated in the other direction—that beam in principle could be extracted using an intracavity mirror that is not used in this present work. This model includes the SFM process, and shows that very different dynamics can develop by including the SFM process.

The applicant presents below a set of rate equations that can be used to model the behaviour of the laser. The terms in Eqs. (1-3) are aligned vertically in labeled groups according to their origin.

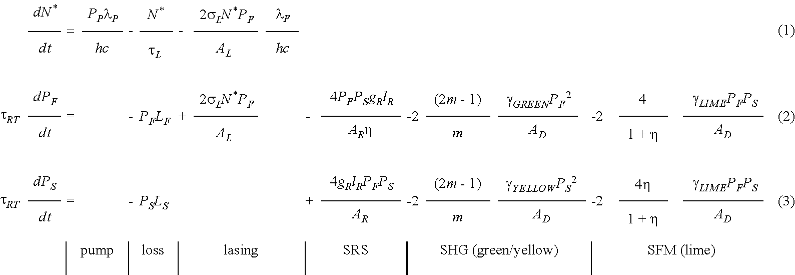

The equations describe the time rate of change of N*, P_{F}, and P_{S}, where N* is the total number of inverted ions, and P_{F}, P_{S} are fundamental and Stokes one-way intracavity powers. In the laser-, Raman-, and doubling-crystals respectively: A_{L}, A_{R}, A_{D}, are the spot areas (with corresponding spot radii r_{L}, r_{R},r_{D}), l_{L}, l_{R}, l_{D} are the crystal lengths, and n_{L}, n_{R}, n_{D} are the crystal refractive indices (assumed equal at all wavelengths). L_{F}, L_{S} are the round-trip losses for the fundamental and Stokes fields (including mirror transmissions). The cavity round trip time is τ_{RT}=2l/c, in which the cavity optical length l=[l_{c}+l_{L}(n_{L}−1)+l_{R}(n_{R}−1)+l_{D}(n_{D}−1)], with l_{c} the physical cavity length. With these definitions, note tha τ_{RT}P is then the intracavity energy stored in each field τ_{L},τ_{L} are the laser crystal emission cross section and upper-level lifetime, g_{R} is the stimulated Raman gain coefficient, P_{P} is the absorbed diode pump power, λ_{P}, λ_{F}, λ_{S} are the wavelengths of the pump, fundamental, Stokes radiation, and η=λ_{F}/λ_{S}. Three ‘output coupling’ routes are included: SHG of P_{F} to generate green, SFM of P_{F} and P_{S} to generate lime, and SHG of Ps to generate yellow. The parameters γ_{GREEN}, γ_{LIME}, and γ_{YELLOW} describe strength of these three χ⁽²⁾ process, calculated to be:

$${γ}_{OUT} = \frac{2 {π}^{2} {d}_{eff}^{2} {l}_{D}^{2}}{{ɛ}_{0} {cn}^{3} {λ}_{OUT}^{2}} sin {c}^{2} [ π ( t - {t}_{OUT}^{PM} ) {l}_{D} \text{/} Δ {t}_{OUT}^{PM} ] \qquad ( 1 )$$

in which the ‘OUT’ subscripts should be replaced throughout by one of ‘GREEN’, ‘LIME’ and ‘YELLOW’. d_{eff} is the effective non-linearity of the doubling crystal, and λ_{OUT} is the generated wavelength. These γ parameters include the temperature dependence of the conversion efficiency for each output wavelength in the sinc² term, where t is the crystal temperature, t_{OUT}^{PM} is the phase matching temperature, and Δt_{OUT}^{PM} is the temperature acceptance bandwidth (defined as the range over which l_{D}Δk ranges from −π to π, where Δk is the wavevector mismatch between the infrared and generated visible fields). For most temperatures, just one of these processes will dominate. Finally the applicant can deduce the output powers in the visible as:

$$\begin{matrix}{P}_{GREEN}^{out} = \frac{( 2 m - 1 )}{m} \frac{{γ}_{GREEN} {P}_{F}^{2} {T}_{GREEN}}{{A}_{D}} & ( 2 ) \\ {P}_{LIME}^{out} = \frac{4 {γ}_{LIME} {P}_{S} {P}_{F} {T}_{LIME}}{{A}_{D}} & ( 3 ) \\ {P}_{YELLOW}^{out} = \frac{( 2 m - 1 )}{m} \frac{{γ}_{YELLOW} {P}_{S}^{2} {T}_{YELLOW}}{{A}_{D}} & ( 4 )\end{matrix}$$

where T_{GREEN}, T_{LIME}, and T_{YELLOW} are the output coupler transmissions at each visible wavelength, and m is the number of longitudinal modes oscillating in the relevant infrared field.

By setting Eqs. (1-3) to zero and solving, the applicant found the steady-state values of all variables appropriate for stable CW lasing. Key points to note are as follows. The SHG coefficients have a factor (2m−1)/m that accounts for up to a factor of two enhancement of the doubling due to mode beating of m longitudinal modes, and the extra factor 4 for SFM accounts for the increased non-linearity compared to the SHG process. For SFM, the power coupled out of the cavity is depleted unevenly from the fundamental and Stokes fields in the ratio of the photon energies. Both forward- and backwards-SRS are included, and both have equal strength in this regime where the dispersion between the fundamental and Stokes fields is large over the characteristic length for Raman gain. Note that backwards-SRS was omitted in the model in.

The model is generic and could be applied to any intracavity Raman laser with intracavity frequency mixing, not just the miniature lasers discussed below. The applicant briefly discusses here the caveats that should be considered before applying the model more generally. The equations are framed in terms of beam power, and include a factor from an overlap integral that arises when the intensity rate equations are integrated over the transverse intensity distributions. For example, the Raman process, which is proportional to I_{F}(r)I_{S}(r), leads to a term ξP_{F}P_{S} where ξ is the normalized overlap integral ∫I_{S}(r)I_{F}(r)dA/(∫I_{S}(r)dA×∫I_{F}(r)dA); a similarly-defined factor ξ is also appropriate for the laser gain and χ⁽²⁾ terms. The equations assume matched Gaussian transverse profiles with 1/e² radius r, for which ξ has the value of 1/πr², resulting in the 1/A factor in all lasing, Raman and χ⁽²⁾ terms.

A second assumption is that the mode sizes are constant throughout each individual crystal (although the sizes can be different in the different crystals). For lasers in which this cannot be assumed, Boyd and Kleinman coefficients are used for the χ⁽²⁾ process and suitably-averaged spot sizes in the Raman and laser crystals. Finally, it is assumed that the fundamental spectral width is narrow compared to the spontaneous Raman linewidth, and that the all fields are spectrally narrow compared to the tolerance of the χ⁽²⁾ processes.

For lower power lasers that are addressed below, these approximations are valid. For multiwatt lasers of this type however, the transverse profiles do actually depart substantially from Gaussian, with the result that the effective strengths of the χ⁽²⁾ and Raman processes are reduced. The spectrum can also become broadened at higher powers, resulting in a reduction in the effective Raman cross-section. Both these effects are beyond the scope of the current model, but generally may cause a decrease in experimental efficiency and output power as they arise.

### Analysis of a Miniature Raman Laser

The applicant models a laser comparing the predictions of the model to experimental data; they will use the model to illustrate the physics of this complex laser system, and make predictions of the optimum configurations of such a laser.

The parameters for this laser are listed in Table 2; the applicant briefly summarise key data since they underpin the analysis presented in the present work. The experimental work used a 3-mm long Nd:YVO₄ self-Raman crystal, and either a 5-mm or 10-mm long LBO crystal, pumped by up to 3.8 W of diode power at 808 nm. Lasing at 1064 nm and generating an intracavity Stokes field at 1176 nm, the laser could be configured either to double the Stokes field to output a 588 nm yellow wavelength, or to sum-frequency-mix the fundamental and Stokes fields to output a 559 nm lime wavelength. The output wavelength could be selected simply by changing the temperature of the LBO crystal to phase-match the desired process. With the 10 mm LBO crystal, up to 420 mW at 559 nm (lime) and 195 mW at 588 nm (yellow) was generated. Using the 5 mm LBO crystal, a substantially increased output power of 660 mW of lime and 320 mW of yellow was generated

Maintaining low intracavity loss may make an efficient CW Raman laser, and the predictions of the numerical model may rely on an accurate determination of these losses. Experimental measurements of the thresholds of the lasers and the intracavity mode size were used to infer their intracavity losses. Losses were calculated to be 0.286% for the cavity with 10 mm LBO, 0.214% for the cavity with 5 mm LBO, and 0.145% for a cavity with no LBO; the conclusion drawn was that the losses associated with the LBO were almost entirely due to bulk losses of 0.07%. cm⁻¹, so that the LBO loss was proportional to its length.

TABLE 2
Parameter values for self-Raman Nd:YVO₄, LBO (Type I doubling using
non-critical phase matching) and laser details.

| General | |
|---|---|
| Parameters | Value |
| λ_{P} | 808 nm |
| λ_{F} | 1064 nm |
| λ_{S} | 1176 nm |
| λ_{GREEN}, λ_{LIME}, λ_{YELLOW} | 532, 559, 588 nm |
| n_{L} | 2.1 |
| n_{R} | 2.1 |
| n_{D} | 1.6 |
| τ_{L} | 90 μs |
| σ_{L} | 14.1 × 10⁻¹⁹ cm² |
| g_{R} | 4.5 × 10⁻⁹ cm/W |
| d_{eff} | 8.4 × 10⁻¹³ m/V |
| t_{GREEN}^{PM}, t_{LIME}^{PM}, t_{YELLOW}^{PM} | 150 C., 89 C., 41 C. |
| Δt_{GREEN}^{PM}, Δt_{LIME}^{PM}, Δt_{YELLOW}^{PM} | 5.4, 6.2, 7.2 K.cm |
| l_{R}, l_{L} | 3 mm (self-Raman) |
| l_{D} | either 5 mm, or 10 mm |
| Aₗ, A_{R}, A_{D} | 2.9 × 10⁻⁴ cm² |
| L_{F}, L_{S} | 0.145% with no |
| | LBO |
| | 0.214% with 5 mm |
| | LBO |
| | 0.285% with |
| | 10 mm LBO |
| T_{LIME}, and T_{YELLOW} | 80%, and 95% |
| P_{P} | 3.8 W |
| (2m − 1)/m | ≈2 |

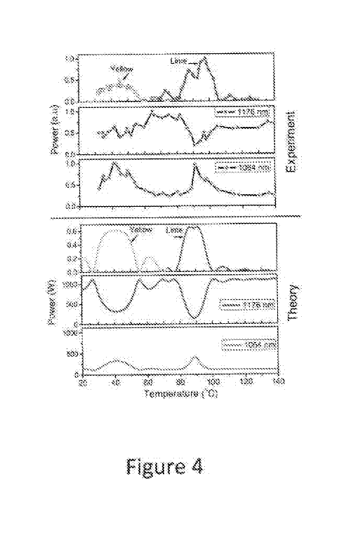

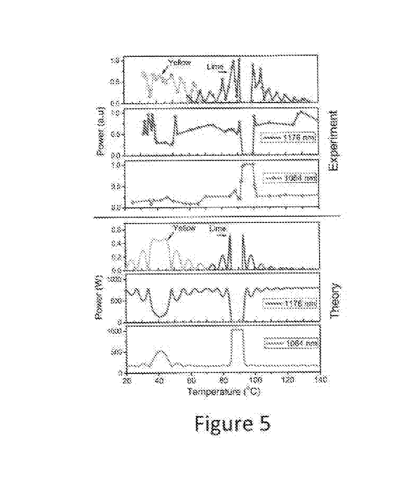

There is a complex dependence of the output power at each visible wavelength on the temperature of the LBO crystal: explaining and exploring this behaviour is the first task to which we apply our present model. FIGS. 4 and 5 show the visible output powers as well as the intracavity fundamental and Stokes field intensities. Plotted along with each are the corresponding predictions by our numerical model. Specifically, FIG. 5 shows experimental measurements (top) and numerical predictions (bottom) for power at the visible (top panel), Stokes (middle panel), and fundamental (bottom panel) wavelengths as a function of LBO temperature, for a laser using a 10 mm long LBO crystal. For the laser with a 5 mm long LBO, the model predicts a maximum lime output of 655 mW, and maximum yellow output of 612 mW (c.f 660 mW and 320 mW from experiments). For 10 mm LBO (FIG. 5), the model predicts a maximum lime output of 521 mW, and maximum yellow output of 467 mW (c.f 420 mW and 195 mW from experiments). These model predictions are broadly consistent with experiment; however the emphasis of this paper is on the behaviour of all the fields as a function of temperature, for which the applicant sees excellent agreement.

Consider first the experimental and theoretical predications for the laser with a 5 mm LBO crystal in FIG. 4. In both plots, the peak output power for yellow and lime are centred around their phase matched temperature (41 C and 89 C respectively theoretically, with the small temperature offset of the experimental results compared to these values attributed to a temperature difference between the monitored position on the crystal mount and the crystal axis). The peaks are broad because of the large temperature tolerance for the short χ⁽²⁾ crystal—the width of the peaks (defined as the temperature range between the zeros on either side of the peaks) is equal to that of the sinc² function in γ_{OUT} describing the temperature response of the phase matching—this width is given by 2Δt_{OUT}^{PM}/l_{D}, and is 28.8 C and 24.8 C for the 5 mm crystal for yellow and lime respectively. The Stokes field is reduced in strength around the phase matching temperature for yellow and lime, when the visible output presents the highest loss to the Stokes field. The reduced Stokes field presents lower loss to the fundamental field which therefore strengthens, even for lime output when there is also a frequency-mixing loss for the fundamental.

For the laser with a 10 mm LBO crystal (FIG. 5), very unusual behaviour, was observed.

The visible outputs show more rapid variations as the temperature is tuned off the central maxima of the sinc² functions in γ_{OUT}, and into the smaller local maxima—note that the scale of the structure as a function of temperature is half that compared to the 5 mm crystal results because of the 1/l_{D} term in the since function argument. The yellow output shows a very broad maximum around its phase matching temperature, with the model predicting a slight dip precisely at phase matching, indicating that the effective output coupling presented to the Stokes field by the doubling process is higher than optimum. For both experiment and theory, the maximum lime output does not occur at the phase matched temperature of 89 C: indeed the lime output ceases entirely for a temperature range of 7.5 C around that temperature. In this range there is a total absence of any Stokes field despite a greatly enhanced fundamental field. Complete suppression of Stokes using the 10 mm LBO crystal when the temperature is tuned for generating lime output has been attributed to the competition between the Stokes shifting process and the sum-frequency-mixing process. The applicant can now derive this result using the full equations above.

Consider the form of the gain and loss terms for the Stokes field. SRS presents gain for the Stokes field that is proportional to the strength of the fundamental field; SFM of the fundamental and Stokes fields also presents loss to the Stokes field that is proportional to the strength of the fundamental field. The applicant can thus rewrite Eq. (3) as

$$\begin{matrix}{τ}_{RT} \frac{d {P}_{S}}{d t} = - {P}_{S} {L}_{S} + ( α - β ) {P}_{F} {P}_{S} & ( 5 ) \\ in which & \\ ( α - β ) = ( \frac{4 {g}_{R}}{{A}_{R}} {I}_{R} - \frac{2}{{A}_{D}} \frac{4 η}{1 + η} {γ}_{LIME} ) & ( 6 )\end{matrix}$$

and where γ_{YELLOW} is set to zero. Both the SRS and the SFM processes are proportional to P_{F}P_{S}, allowing those terms to be collected to define an effective Raman gain coefficient (α−β). This coefficient can be negative if the SFM is too strong, leading to no generation of a Stokes field. Note that in this regime, it is not simply that the effective output coupling presented to the Stokes field by the SFM is high enough to cause the Stokes process to drop below threshold: in fact the Stokes field will not lase for any pump power, nor will changing the cavity losses make any difference. Stokes photons are coupled out of the cavity by SFM at a greater rate than they are amplified by SRS, and so the Stokes field does not grow from the spontaneous noise level regardless of the power in the fundamental field.

For the parameters from Table 2 and Eq. (9), the applicant can calculates that for a 3 mm Nd:YVO₄ crystal, the LBO crystal must be less than 5.9 mm long to prevent suppression of the Stokes field at the phase matching temperature for lime generation. This is consistent with the applicant's experimental observation of suppression using 10 mm LBO but not with 5 mm LBO. Of course, for crystals longer than 5.9 mm, as the temperature is tuned away from the phase matching temperature the decreasing since term in γ_{LIME} will at some point cause (α−β) to become positive, and the lime output will abruptly resume. This is clearly seen in both the experimental and modeling data in FIG. 5 as the sharp peaks in lime output a few degrees above and below the phase matching temperature.

### Optimization of Crystal Lengths

The applicant now considers how the lengths of the laser and Raman crystals should be chosen to optimize the output power of miniature Raman lasers of this type. Optimization of these lasers is complicated by the fact that bulk crystal losses can be the dominant contributor to the intracavity losses. For modeled and experimental laser, the 10 mm LBO crystal is clearly longer than optimal for lime and yellow generation. While the temperature can be detuned in order to reduce the non-linearity until a maximum in the output power is reached, higher output power must be possible for a shorter LBO crystal, since the shorter crystal will have lower bulk loss and so decrease the intracavity losses and increase the laser efficiency. Accordingly, the 5 mm LBO crystal gives higher output powers for both lime and yellow wavelengths.

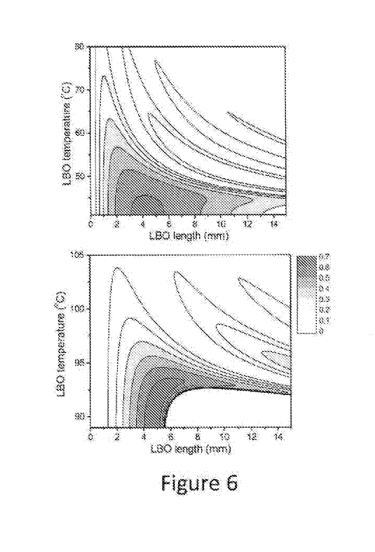

The applicant uses the model to further study the optimum length for the LBO crystal in these lasers for both lime and yellow generation. FIG. 6 shows the predicted output powers for lime and yellow for different temperature ranges, as a function of LBO length. Note that each plot has mirror symmetry about the phase matching temperature (41 C and 89 C for the yellow and lime respectively) and so the behaviour is only plotted at the matching temperature and above. Also note that the plots in FIG. 6 are vertical cuts through these plots for LBO lengths of 5 mm and 10 mm.

As the length of the LBO is changed, the cavity loss is reduced as the bulk losses of the LBO decrease—cavity losses for both the fundamental and Stokes fields are modeled as (0.145+0.14×l_{D}/cm)% in accordance with measurements. There are then three key effects as the LBO length is reduced: the cavity losses decrease; the strength of the χ⁽²⁾ non-linearity decreases; and the temperature acceptance range increases.

The upper plot in FIG. 6 shows the behaviour for yellow output. The optimum output power of 619 mW is predicted for an LBO length of 4.25 mm. The maxima for the output power must occur for a phase-matched crystal—while the same non-linearity could be achieved for a longer crystal that was detuned in temperature, that crystal would present an increased cavity loss and so reduce output power. The lower plot in FIG. 6 shows the lime output. The white area in the bottom right corresponds to the regime of Stokes suppression, for which lime output is only achieved by detuning the LBO from the phase matching temperature. Suppression is not observed for crystal lengths shorter than 5.9 mm as predicted above. The optimum LBO length of 4.75 mm gives a predicted output of 663 mW. These results indicate that the 5 mm LBO crystal used in our experiments may have been quite close to the optimal length.

While the applicant's experiments only considered scaling the length of the LBO crystal, they also considered the effects of scaling the length of the self-Raman Nd:YVO₄ crystal. This will alter the cavity losses, the amount of Raman material per round trip, as well as the pump absorption and so round-trip gain. An assumption must be made about the losses associated with the Nd:YVO₄ crystal: measurements place the loss of the cavity and a 3 mm crystal at 0.145%, and for the present simulations it is estimated that the fixed cavity losses (mirror losses, crystal surface losses) are 0.02%, with 0.125% attributed to bulk losses in the Nd:YVO₄. These extremely low fixed losses are consistent with the high-quality HR and AR coatings as measured by the supplier. The total roundtrip loss can then be written (0.02+0.125×l_{L}/cm+0.14×l_{D}/cm)%. Possible incomplete pump absorption must also be accounted for, which is modeled using an experimentally-determined absorption of 25 cm⁻¹ for our 1 at. % Nd:YVO₄ crystals for the linearly-polarised 808 nm source, giving for example 99.9% absorption for a 3 mm crystal, and 92% for a 1 mm crystal.

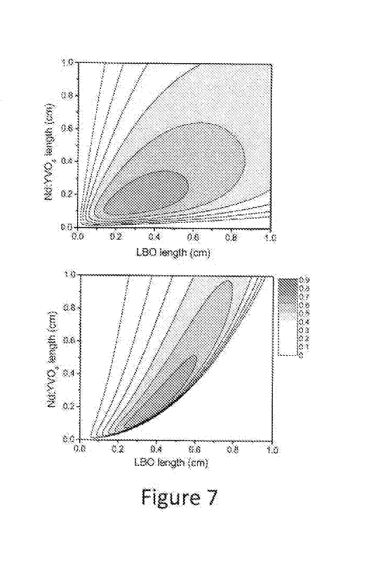

In FIG. 7 the applicant plots yellow (top) and lime (bottom) output against the lengths of the two crystals. In particular, FIG. 7 shows theoretical predictions for yellow (top) and lime (bottom) power output in watts from the laser as a function of the LBO length and Nd:YVO₄ length. Note that as the crystal lengths change, the pump absorption and cavity losses are scaled accordingly, but the mode size is fixed. The LBO temperature is now set to the phase matching temperature in all cases, and the pump power is set to 3.8 W. Optimum operation requires a balance between the Raman and SFM/SHG processes. For the yellow laser, FIG. 7 (top), for which the LBO is set to 41 C, there is a broad maximum in the power with the highest output of 670 mW for a 1.5 mm long Nd:YVO₄ crystal, and a 2.75 mm LBO crystal. FIG. 7 (bottom) shows the predicted lime power output, with the LBO temperature set to 89 C. The region in the lower right of the plot is that for which complete suppression of the Stokes occurs, and the limit of this region is the parabola defined by setting (α−β)=0 in Eq. (6). The highest power output is 693 mW, for a 1.75 mm long Nd:YVO₄ crystal, and a 3.75 mm LBO crystal.

The results in FIG. 7 assume a fixed mode area as measured in, in Table 1, and predict that modestly increased efficiency could be achieved for crystal lengths significantly shorter than the 3 mm Nd:YVO₄ and 5 mm LBO used in another experiment. However shorter crystals would permit shorter cavities, tighter diode focusing and smaller mode sizes: reducing the mode size in such a simple linear cavity is constrained by the need for the Rayleigh range of the diode pump light to be comparable to the pump absorption depth, and for the Rayleigh range of the cavity modes to be comparable to the cavity length. By also decreasing the mode size as the crystal sizes are decreased, the applicant can expect further increases in output power to be possible—for example, they predict that decreasing the mode area by a factor of two would increase the maximum lime and yellow output achievable by approximately 20%.

The simulations for both lime and yellow show that a balance is required between the χ⁽²⁾ and χ⁽³⁾ non-linearities, and as the length of one crystal is increased, the length of the other should be increased to maintain that balance. The optimum crystal lengths are just a few mm: This is quite different to most previous lasers of this type for which far longer crystals of order 10 to 20 mm were used. The surprising success of such short crystals owes partly to the smaller cavity modes used in the present work (enabled by using higher doped laser crystals with shorter absorption length), but mainly to the fact that the cavity losses are now dominated by bulk losses in the crystals, and so shorter crystals are accompanied by substantially reduced total round trip losses. These considerations also provide a rule of thumb for best efficiency to prefer a self-Raman laser configuration compared to one using separate laser and Raman materials, since the total length of crystal material in the cavity can be reduced.

The applicant considers how they have reached experimentally the regime where bulk losses are the dominant remaining losses. Negligible losses must exist at the cavity mirrors (achieved with excellent coatings, >99.99%) and there must be no significant loss contribution from the crystal surfaces. Even though the intracavity surfaces are anti-reflection coated, it may be vital that the intracavity surfaces act as low-finesse etalons to select longitudinal modes that do not experience reflection losses. This is more easily achieved if the number of surfaces is reduced (direct HR coatings and a self-Raman configuration leave just three intracavity surfaces). It may also be important that the laser operates with a high beam quality, since it will not necessarily be the case that higher order transverse modes will also experience low surface loss.

### CONCLUSION

The applicant has presented a rate-equation model for a continuous wave laser with simultaneous intracavity Raman conversion and SFM/SHG conversion, in which the temperature of the intracavity LBO crystal can be used to select between yellow output (SHG of the Stokes field) and lime output (SFM of the fundamental and Stokes fields). The model can be applied to any such laser; it is applied to a miniature Raman laser pumped by a 3.8 W laser diode. The model predicts visible output powers and intracavity Stokes and fundamental fields that closely replicate experimental measurements, fully explaining the complex behaviour that results when the χ⁽²⁾ process suppresses the generation of the Stokes field when configured for sum-frequency mixing. For the lime laser, this means that if the LBO crystal is too long, there will be no lime output no matter how hard the laser is pumped. For both lime and yellow lasers, the applicant concludes that a balance between the χ⁽²⁾ and χ⁽³⁾ non-linearities is essential for efficient operation.

The applicant has also applied the model to explore the optimum crystal lengths for maximizing the efficiency of this miniature architecture, taking into account the intracavity losses associated with each crystal. The model predicts that once the intracavity losses in CW Raman lasers designs are reduced close to the limit in which the bulk losses of the crystal are the main contribution, it becomes increasingly advantageous to use crystals only a few millimeters long.

It will be appreciated that the suppression mechanism described above may be used as a control mechanism in a laser with two second order nonlinear crystals, as disclosed above.

Variations and/or modifications may be made to the embodiments described without departing from the spirit or ambit of the invention. For example, the light resonating structure may comprise a ring resonator, a Z-resonator, an integrated photonic device, a photonic crystal, or generally any suitable structure that resonates light. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1.-35. (canceled)

36. A method for increasing generation of a light, the method comprising the step of using a nonlinear process that reduces the extraction of power from a precursor resonating light by a Raman process in which the precursor resonating light interacts with a Raman medium to generate a resonating Raman light and wherein the nonlinear process involves passing the precursor light through a second order nonlinear medium tuned for interacting with the precursor light and the resonating Raman light for generating another light having a frequency that is the sum of the precursor light's frequency and the resonating Raman light's frequency, the reduction in the extraction of power from the precursor resonating light enhancing the extraction of power from the precursor resonating light by another nonlinear process that generates the light.

37. A method defined by claim 36 wherein a resonating Raman light gain due to the precursor resonating light interacting with the Raman medium is less than a resonating Raman light loss from the passing of the precursor light through the second order nonlinear medium.

38. A method defined by claim 37 comprising the step of tuning the second order nonlinear medium for interacting with the precursor light and the resonating Raman light for generating the other light.

39. A method defined by claim 38 wherein the step of tuning the second order nonlinear medium comprises the step of orientating the second order nonlinear medium.

40. A method defined by claim 39 wherein the step of tuning the second order nonlinear medium comprises the step of changing the temperature of the second order nonlinear medium.

41. A method defined by claim 36 wherein the other nonlinear process comprises a nonlinear interaction of the precursor resonating light with another second order nonlinear crystal.

42. A method defined by claim 36 comprising the step of generating the precursor resonating light using a laser medium having an invertable population for generation of a laser light.

43. A method defined by claim 42 wherein the laser medium comprises the Raman medium.

44. A method defined by claim 36 wherein the Raman light is selected from one of a cascade of resonating Raman lights.

45. A method defined by claim 36 comprising the step of using the nonlinear process to suppress the extraction of power from the precursor resonating light.

46. A laser comprising:
a light resonating structure configured to resonate a precursor resonating light, the light resonating structure having a Raman medium configured to interact with the precursor resonating light when so resonating in the light resonating structure to generate a Raman light by a Raman process;
a nonlinear medium configured to reduce an extraction of power from the precursor resonating light by the Raman process the nonlinear medium comprising a second order nonlinear medium configured to have the resonating precursor light pass therethrough and being tunable to interact with the precursor light and the resonating Raman light for generating another light having a frequency that is the sum of the precursor light's frequency and the resonating Raman light's frequency; and
another nonlinear medium configured to interact with the precursor resonating light to generate a light thereby extracting power from the precursor resonating light;
whereby in use the nonlinear medium reduces the extraction of power from the precursor resonating light by the Raman process to enhance the extraction of power from the precursor resonating light by the other nonlinear medium interacting with the precursor resonating light thereby increasing the power of the light.

47. A laser defined by claim 46 configured to provide a resonating Raman light gain due to the precursor resonating light interacting with the Raman medium that is less than a resonating Raman light loss from the passing of the precursor light through the second order nonlinear medium.

48. A laser defined by claim 47 comprising a second order nonlinear medium tuner arranged to tune the second order nonlinear medium.

49. A laser defined by claim 48 wherein the second order nonlinear tuner is arranged to orientate the second order nonlinear medium.

50. A laser defined by claim 49 wherein the second order nonlinear medium tuner is arranged to control the temperature of the second order nonlinear medium.

51. A laser defined by claim 46 wherein the other nonlinear medium comprises another second order nonlinear crystal.

52. A laser defined by claim 46 wherein the Raman medium comprises a crystal of at least one of tungstate, potassium gadolinium tungstate, barium tungstate, molybdenate, barium nitrate, vanadate, gadolinium vanadate, and diamond.

53. A laser defined by claim 46 comprising a laser medium having an invertable population by which the precursor light is generated.

54. A laser defined by claim 53 wherein the laser medium comprises the Raman medium.

55. A laser defined by claim 46 whereby in use the nonlinear medium suppresses the extraction of power from the precursor resonating light by the Raman process.
